(19) United States
(12) Patent Application Publication
(10) Pub. No.: US 2026/0179814 A1
(43) Pub. Date: Jun. 25, 2026

(54) NON-NEODYMIUM (Nd) PERMANENT MAGNETIC MATERIAL AND PERMANENT MAGNET USING THE SAME

(71) Applicants: POSTECH RESEARCH AND BUSINESS DEVELOPMENT FOUNDATION, Pohang-si (KR); MAX PLANCK POSTECH/KOREA RESEARCH INITIATIVE, Pohang-si (KR)

(72) Inventors: Ji Hoon SHIM, Pohang-si (KR); Chang Hoon LEE, Pohang-si (KR); Jae Hoon PARK, Pohang-si (KR)

(73) Assignees: POSTECH RESEARCH AND BUSINESS DEVELOPMENT FOUNDATION, Pohang-si (KR); MAX PLANCK POSTECH/KOREA RESEARCH INITIATIVE, Pohang-si (KR)

(21) Appl. No.: 19/126,635

(22) PCT Filed: Sep. 15, 2023
(86) PCT No.: PCT/KR2023/013898

§ 371 Date: May 1, 2025

(30) Foreign Application Priority Data
Nov. 2, 2022 (KR) 10-2022-0144421

(51) Int. Cl. H01F 1/059

(52) U.S. Cl. CPC H01F 1/0593

(57) ABSTRACT

In one or more aspects, a CeFe₁₂-based compound is provided as a permanent magnet for replacing a conventional neodymium magnet Nd₂Fe₁₄B. In one or more aspects, the instability of the CeFe₁₂-based compound has been controlled, improving the magnetic properties of CeFe₁₂, through Ce f-orbital stabilization by supplying electrons to a CeFe₁₂ system through the insertion of a non-metallic element and the insertion of an element having an atomic size greater than that of Fe, and improving coercivity by increasing the orbital angular momentum of the Ce f-orbit to increase magnetic anisotropy. The CeFe₁₂-based compound with improved coercivity has been provided through the substitution of 4d- and 5d-transition metals having a spin-orbit interaction greater than that of Fe, and a non-metallic element is inserted into CeFe₁₁M, in which dynamic instability has been resolved, in order to increase coercivity, and thus usefulness in actual synthesis and application has been demonstrated.

### TECHNICAL FIELD

The present invention relates to a magnetic material and a permanent magnet that excluding neodymium (Nd), and more specifically, to a permanent magnet with improved efficiency and a magnetic material that greatly improves the stability of the magnetic material.

### BACKGROUND ART

Permanent magnets are essential and core components in advanced industries, and are widely used in aerospace, industrial motors, automobiles, home appliances, and mobile devices. Magnets can be largely classified into three categories with neodymium magnets and ferrite magnets are the most widely used for industrial purposes.

Although information storage devices, home appliances, and automobiles, which primarily use permanent magnet materials, are key national industries, Korea heavily relies on neighboring countries due to a lack of material resources, as well as a shortage of material technology and manufacturing infrastructure. Currently, China accounts for more than 95% of the production of rare earth elements, which are used in permanent magnets. Due to China's export restrictions, driven by the weaponization of resources, supply issues and price surges are expected to occur. Additionally, Japan possesses the world's leading technology in the materialization and recycling of natural resources, and approximately 40% of rare earth resources are imported from Japan. Recently, social awareness of external dependence in all industrial fields owing to export regulations by Japan and China, such as materials and parts, has increased, and the need to secure alternative technologies has been steadily growing. Therefore, new non-neodymium (Nd) metal materials that can replace neodymium (Nd) in all industries, or high-performance permanent magnet material technology utilizing ferrite materials, which are highly specialized, easy to materialize into parts, and highly usable, are required for securing and commercializing.

National Research and Development Project that Supported this Invention
Project Unique Number: 1711158472
Project Number: 2020M3H4A2084418
Ministry: Ministry of Science and ICT
Project Management (Specialized) Organization: National Research Foundation of Korea
Research Project Name: Nanomaterial Technology Development
Research Project Name: Development of Advanced Composite Magnetic Material Design to Replace Scarce Resources
Contribution Rate: 1/1
Project Execution Organization Name: Max Planck Institute for Korea POSTECH
Research Period: 2022 Jan. 1˜2022 Dec. 31

### DETAILED DESCRIPTION

### Technical Problems

Accordingly, the aim of present invention is to propose a permanent magnet CeFe₁₂ series permanent magnet that can replace neodymium ((Nd) series permanent magnets, and to suggests a way for improving the magnetic properties and stabilizing CeFe12 materials. Thereby improving the stability of CeFe₁₂ series materials and enabling their synthesis, and to provide a permanent magnet material that can replace Nd series permanent magnets by improving the coercivity that is relatively low compared to the performance of neodymium-series (Nd series) permanent magnets.

### Technical Solution

The permanent magnet material according to an exemplary embodiment in the present invention is a CeFe12A compound, where the intercalated A is a material that forms a coordination bond between Ce and A in Ce-A-Ce.

At this time, the negative vibration frequency of CeFe₁₂ can be removed from the phonon behavior by the intercalation of the A.

Desirably, the A can be formed of atoms whose valence electrons do not include d-orbital electrons.

For example, The A includes at least one element selected from B, C, N, Al, Si, P, Ga, Ge, and As elements.

A permanent magnet material according to another exemplary embodiment of the present invention is expressed as CeFe₁₁M by substituting a transition metal M having an atomic size larger than Fe to remove dynamic instability of CeFe₁₂.

For example, the transition metal M can include at least one of a 4d-transition metal or a 5d-transition metal.

For example, the transition metal M may include at least one of Ti, V, Cr, Zr, Nb, and Mo.

A permanent magnet material according to another exemplary embodiment of the present invention is a CeFe₁₁MA compound, wherein M includes at least one of a 4d-transition metal or a 5d-transition metal, and A includes atoms whose valence electrons do not include d-orbital electrons.

For example, M include at least one of Ti, V, Cr, Zr, Nb, and Mo, and A may include at least one selected from B, C, N, Al, Si, P, Ga, Ge, and As.

A permanent magnet according to the present invention includes the permanent magnetic material mentioned above.

More specifically, according to an exemplary embodiment of the present invention an electronic material includes a intercalated lattice structure in which B, C, N, Al, Si, P, Ga, Ge, As, etc. are intercalated into loose sites of lattice in CeFe₁₂ [CeFe₁₂M (M=B, C, N, Al, Si, P, Ga, Ge, As)]. The CeFe₁₂A compound has a three-dimensional tetragonal crystal system structure and includes a material in which B, C, N, Al, Si, P, Ga, Ge, As, etc. are intercalated into loose sites of lattice. In the CeFe₁₂A, A is an atom whose valence electron does not include a d-orbital electron, and atoms donating electrons to the CeFe₁₂ system must be intercalated.

Preferably, in the CeFe₁₂A, A is forming a coordination bond between Ce-A-Ce.

In the above CeFe₁₂A compounds, A element plays a role in providing electrons to the system, and the more electrons are provided, the spin-exchange interaction becomes stronger, leading to an increase in the Tc (see FIG. 6). Therefore, in the CeFe₁₂A compound, nitrogen group elements, which have more electrons, are more beneficial for A.

According to the embodiment, the electronic material includes CeFe11M where some of the Fe elements on CeFe12 are substituted with 3d or 4d transition metals (M=3d transition metal elements, 4d transition metal elements).

For example, in the CeFe₁₁M compound, the dynamic stability of CeFe₁₂ is increased by substituting another transition metal to the Fe atom site. In the CeFe₁₁M compound, elements that are easy to substitute and suitable for the Fe site are preferably Ti, V, Cr, Zr, Nb, Mo, etc., which have a larger atomic size than Fe (FIG. 11). Namely, it is desirable to slightly deform the lattice of CeFe₁₂ by substituting elements, which have larger atomic size than that of Fe, to increase the electron density near Fermi, and to lead the dynamic stability of CeFe₁₂, and to increase the Curie temperature and magnetic anisotropy energy.

In addition, the transition metal substitution to the Fe site in the CeFe₁₁M compound leads the dynamic stability of CeFe₁₂, and can secure the dynamic stability when an element larger atomic size than that of Fe is substituted.

In the permanent magnet material according to exemplary embodiment, when a 4d-transition metal with a large spin-orbit coupling effect is substituted to the Fe site in the CeFe₁₁M compound, the Curie temperature decrease slightly, but the relatively large spin-orbit coupling effect of the 4d-transition elements contributes to the magnetic anisotropy, and an increase in the coercivity should be expected.

In addition, in the above CeFe₁₁M (M=4d, 5d-transition element), electronic structure modification is induced by M substitution, which can resolve preferably the dynamic instability of CeFe12.

In the above CeFe₁₁M, M is preferably Zr, Nb, W, etc., which have a larger atomic size than Fe and strong spin-orbit coupling effect.

### Technical Effects

According to the present invention, since China currently accounts for more than 95% of the production of rare earths, one of the permanent magnet materials, it is expected that resource supply issues and price surges caused by China's export restriction policy due to the weaponization of resources can be overcome. Additionally, it is anticipated that significant economic profits can be generated, as it can be used as a gap permanent magnet. Since Japan has the world's highest level of technology in the field of natural resource materialization-recycling, and since rare earth resources, which account for about 40%, are imported from Japan, an import substitution effect will also occur, and it is expected that it will be possible to secure alternative technologies as social awareness of external dependence in all-round industries such as materials and parts has increased due to recent export regulations by Japan and China.

The present invention relates to a CeFe12 series permanent magnet as a replacement for Nd, and to methods for enhancing and stabilizing its magnetic properties. Concerning the low magnetic properties and instability of CeFe12, CeFe12-series compounds face the issue of having very low applicability as permanent magnets. In the present invention, a way to greatly improve the dynamic stability and magnetic properties of the CeFe12 series is proposed in terms of theoretical approach so that trial and error accompanying experiments relying on intuition can be avoided and a dramatic reduction in time and cost can be achieved. In addition, since a synthetic and applicable chemical composition can be proposed through theoretical design, it is possible to provide a systematic and simplified new composition-new material permanent magnet material.

### BRIEF DESCRIPTION OF THE DRAWINGS

FIG. 1 is a schematic diagram showing a three-dimensional structure of CeFe₁₂. In CeFe₁₂, Fe is composed of three types with different chemical environments, namely 8f, 8i, and 8j.

FIG. 2 is a schematic diagram showing a three-dimensional structure of CeFe₁₂ in perspective. As can be seen in the figure, CeFe₁₂ forms a continuous three-dimensional structure in which CeFe₂₀ structures share vertices in the ab direction, and forms a three-dimensional structure in which CeFe₂₀ structures share faces in c direction.

FIG. 3 is a schematic diagram showing the definition of the maximum energy product BHmax. As can be seen in FIG. 3, BHmax depends on coercivity and Curie temperature (Tc), and Tc is determined by spin-exchange interaction.

FIG. 4 is a schematic diagram showing the position where A element is intercalated in CeFe12A (A is B, C, N, Al, Si, P, Ga, Ge, As). A is intercalated between Ce and Ce in the c-direction, forming a structure of Ce-A-Ce. Also, A is mainly affected by Fe (8j) and Ce. Therefore, it should be expected that the electronic structures of Ce and Fe (8j) should be affected by A.

FIG. 5 is an expected the Curie temperature (Tc) in CeFe12A (A is B, C, N, Al, Si, P, Ga, Ge, As) based on DFT calculation. The Curie temperature increases as the A element moves to the nitrogen group, which indicates that nitrogen group elements with more electrons are favorable for enhancing the magnetic properties.

FIG. 6 is the calculated the magnetic anisotropy and Curie temperature for CeFe12A (A is B, C, N, Al, Si, P, Ga, Ge, As). Although the Curie temperature of pure-CeFe12 is the highest, the predicted magnetic anisotropy is very low. However, when A is intercalated into CeFe12A (A is B, C, N, Al, Si, P, Ga, Ge, As), it shows that the magnetic anisotropy is greatly improved and shows the performance of magnet properties comparable to that of Nd-series permanent magnets.

FIG. 7 are the calculated electronic structure and the Curie temperature of CeFe12A (A is B, C, N, Al, Si, P, Ga, Ge, As). It can be predicted that as A in CeFe12A moves from the boron group to the nitrogen group (B→N), the electron density near the Fermi level increases, and the Curie temperature (Tc) increases, which improves the magnetic properties (magnet performance).

FIG. 8 is a schematic diagram showing the simulated phonon behavior using the first-principles calculation that can predict the dynamic stability of CeFe₁₂. In the phonon behavior, the negative frequency value indicates that the compound is unstable. Therefore, it shows that pure CeFe₁₂ is very unstable and it is not easy to synthesize.

FIG. 9 is showing the simulated phonon behavior for CeFe₁₂A (A is B, C, N). In the FIG. 9, the negative frequency of CeFe₁₂ disappears by intercalating A indicating that the intercalation A eliminates the instability of CeFe₁₂, along with increasing the magnetic anisotropy.

FIG. 10 is a predicted the Curie temperature and magnetic anisotropy when Fe is substituted with 4d, 5d transition metal elements with a large spin-orbit coupling effect in CeFe₁₂. The Curie temperature decreases to some extent, but the magnetic anisotropy increases significantly by the substitution of 4d, 5d transition elements, which is a favorable method for improving the coercivity of CeFe₁₂.

FIG. 11 is a graph that can predict the preferred positions and relatively easy-to-substitute elements when the spin-orbit coupling effect substitutes 3d, 4d transition metal elements in the Fe site of CeFe₁₂. In other words, it is a schematic diagram that theoretically predicts the relative energy according to the type of M element and the substitution site when CeFe₁₁M is formed. Most transition metals have been proven to prefer the 8i site Fe site when substituting Fe, and it was revealed that Ti, V, Nb, and Mo, which have larger atomic sizes than Fe, are preferred candidates for substitution.

FIG. 12 is a schematic diagram that illustrates the behavior of phonons to predict the dynamic stability when CeFe₁₁M is formed. The dynamic stability of CeFe₁₂ is resolved when Ti and V atoms, which have larger atomic sizes than Fe, are substituted, but the dynamic stability is not resolved in the case of Co, which has smaller atomic sizes than Fe.

FIG. 13 is a graph showing the phonon behavior for CeFe₁₁MA (A represents B, C, N) where CeFe₁₁M is formed by substituting M (M represents a transition metal element) into CeFe₁₂ and then B, C, and N are intercalated into the loose space of the CeFe11M lattice. According to FIG. 13, it shows that dynamic stability is maintained when B, C, and N are intercalated into CeFe11M. This data proves that if there is difficulty in inserting B, C, and N in future experiments, substituting M first and then intercalating B, C, and N can significantly improve the magnetic properties of CeFe₁₂ and also eliminate the instability of the material.

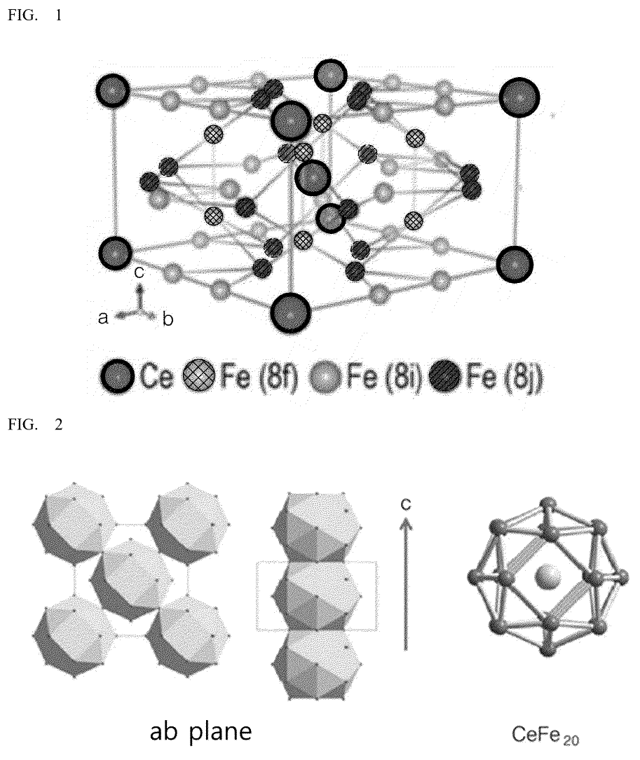

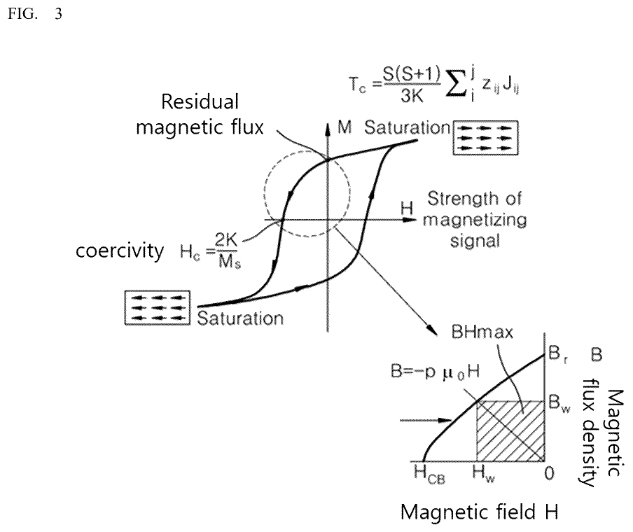

### MODES FOR INVENTION

The present invention can be modified in various ways and can take various forms, and specific embodiments are illustrated in the drawings and described in detail in the text. However, this is not intended to limit the present invention to a specific disclosed form, and it should be understood that it includes all modifications, equivalents, and substitutes included in the spirit and technical scope of the present invention. Similar reference numerals have been used for similar components in describing each drawing. In the attached drawings, the dimensions of structures may be exaggerated compared to the actual dimensions for the sake of clarity of the present invention.

The terms first, second, etc. may be used to describe various components, but the components should not be limited by the terms. The terms are used only for the purpose of distinguishing one component from another. For example, without departing from the scope of the present invention, the first component may be referred to as the second component, and similarly, the second component may also be referred to as the first component.

The terms used in this application are used only to describe specific embodiments and are not intended to limit the present invention. The singular expression includes the plural expression unless the context clearly indicates otherwise. In this application, the terms “include” or “have” are intended to specify the presence of a feature, number, step, operation, component, part, or combination thereof described in the specification, but should be understood as not excluding in advance the possibility of the presence or addition of one or more other features, numbers, steps, operations, components, parts, or combinations thereof. In addition, the meaning of A and B being “connected” or “coupled” includes the connection or coupling of A and B with another component C included between A and B in addition to the direct connection or coupling of A and B. Unless otherwise defined, all terms used herein, including technical or scientific terms, have the same meaning as generally understood by a person of ordinary skill in the art to which the present invention pertains. Terms defined in commonly used dictionaries should be interpreted as having a meaning consistent with the meaning they have in the context of the relevant technology, and shall not be interpreted in an ideal or excessively formal sense unless explicitly defined in this application.

In addition, in the scope of the patent claims for the method invention, unless each step is clearly bound to the order, each step may be changed in its order.

In addition, the configurations individually described in each embodiment may be applied in other embodiments.

Hereinafter, the present invention will be described in detail.

Permanent magnets are essential and core components in advanced industrial fields, widely used across industries ranging from aerospace to industrial motors, automobiles, home appliances, and mobile devices. Magnets can generally be classified into three categories, with neodymium magnets and ferrite magnets being the most commonly used for industrial purposes. Despite the fact that electronic information, home appliances, and automobiles—industries in which permanent magnet materials are primarily used—are key national industries, South Korea heavily depends on neighboring countries due to a lack of material resources and insufficient material technology and manufacturing infrastructure. Currently, China accounts for over 95% of the production of rare earth elements, one of the key materials for permanent magnets, and resource supply issues and price surges are expected to arise due to China's export restrictions, driven by the weaponization of resources. In addition, Japan has the world's highest level of technology in the field of materialization and recycling of natural resources, and approximately 40% of rare earth resources are imported from Japan. Recently, due to export regulations by Japan and China, social awareness of external dependence in all-round industries such as materials and parts has increased, and the need for securing alternative technologies has increased. As an alternative, there is a demand for securing and commercializing high-specification permanent magnet material technology utilizing new non-Nd metal materials that can replace neodymium (Nd) in all industries, or ferrite materials that have high usability and are easy to make into materials and parts due to high specialization. The present invention relates to a CeFe₁₂ series permanent magnet that replaces Nd, and to the enhancement and stabilization of the magnetic properties of CeFe₁₂ permanent magnets.

The magnetic performance of a permanent magnet is defined as the maximum energy product BHmax, which is determined by the coercivity and saturation flux density (FIG. 3). In order to improve the performance of a permanent magnet, the coercive force or the magnetic flux density must be increased. The coercive force depends on the magnetic anisotropy K according to Equation 1, and the magnetic flux density depends on the Curie temperature Tc according to Equation 2.

$${H}_{C} = \frac{2 K}{Ms} \qquad [ Equation 1 ]$$

$${T}_{C} = \frac{S ( S + 1 )}{3 K} {\sum }_{i}^{j} {z}_{ij} {J}_{ij} \qquad [ Equation 2 ]$$

In the above Equations, Tc=Curie temperature, K=temperature (in Kelvin), S=spin moment, and Jᵢⱼ=spin-exchange interaction parameter.

Therefore, in order to improve the properties of permanent magnets, the magnetic anisotropy and the spin-exchange interaction must be improved. According to mathematical expression 3, the magnetic anisotropy is determined by the spin-orbit coupling. According to mathematical expression 3, in order to increase the magnetic anisotropy, the compound must contain a heavy element with a high atomic number, contain a material element with a high spin moment, and a compound containing an f-orbital with a high orbital moment (orbital angular momentum) is advantageous.

$${H}_{OOC} = λ \overline{S} \cdot \overline{L} \qquad [ Equation 3 ]$$

where, λ=spin-orbit coupling constant, L=orbital angular momentum, and S=spin angular momentum.

This magnetic anisotropy of compounds can be predicted from theoretical calculations. Also, it is possible to suggest compounds with new compositions and ways to improve magnetic anisotropy with theoretical approach. This is expected to greatly contribute to the development of permanent magnets and improvement of their properties in a top-down manner, avoiding the trial and error of the existing bottom-up material development way.

In addition, in order to increase Tc, spin-exchange interaction must be strengthened, which induce an increase in interaction via the metal-ligand-metal (M-L-M) path, which can be done by increasing the orbital overlap or increasing the overlap of the electron density. This can also be predicted and designed in terms of the first-principle calculations, thus, it is possible to suggest a permanent magnet with a new composition and to suggest a method for improving the properties of the permanent magnet.

In the present invention, a CeFe₁₂-based compound is proposed as a potential replacement candidate compound for the widely used neodymium magnet, Nd2Fe14B, in current industrial applications. The CeFe12 series compound exhibits magnetic properties comparable to those of the Nd-based magnet. Compared to Nd₂Fe₁₄B, which has a tetragonal crystal structure and a complex network of layered iron atoms, the CeFe12 compound, which has a ThMn12-type structure with uniformly distributed iron, contains a higher proportion of iron and a lower proportion of rare earth elements. Therefore, it is intuitively expected that CeFe12 will exhibit a high Curie temperature. In Nd-based magnets, boron contributes to the formation of strong covalent bonds with Fe. However, in this study, it was found that non-metallic elements can be intercalated between Ce atoms along the c-axis. Although these elements interact weakly, they donate electrons to the CeFe12 system. Furthermore, the magnetic performance of CeFe12A was analyzed by incorporating various non-metallic elements (A=B, C, N, Al, Si, P, Ga, Ge, As).

In the present invention, a permanent magnet of the CeFe₁₂ series (CeFe12A) that can replace the Nd-series permanent magnet was designed using first-principles calculations, and a way for improving the magnetic properties of CeFe12 was provided. Furthermore, a method for improving the stability, which is a problem of the CeFe₁₂ material, was developed.

Hereinafter, embodiments of the present invention will be described in more detail with reference to the drawings.

Improvement of permanent magnet performance and control of dynamic instability of CeFe₁₂ through substitution of non-metallic elements in non-Nd-series permanent magnet material CeFe₁₂.

In the present invention, a CeFe₁₂-based compound is proposed as a potential candidate compound to replace the neodymium magnet Nd₂Fe₁₄B, which is widely applied/commercially used in the industry. The magnetic properties of the CeFe12 series compound exhibit performance comparable to that of the Nd series magnet. Compared to Nd₂Fe₁₄B, which has a tetragonal crystal and a complex network of iron elements in a layered form, the CeFe₁₂ compound, which has a structure of ThMn₁₂ in which iron is uniformly distributed, has a high iron element composition compared to a low rare earth composition. Therefore, it is intuitively expected that CeFe12 will exhibit a high Curie temperature. In Nd-series magnets, boron contributes to the formation of strong covalent bonds with Fe. In contrast, in the present invention, non-metallic elements are intercalated between Ce atoms along the c-axis. While these elements weakly contribute to the formation of covalent bonds (forming coordination bond), they donate electrons to the CeFe12 system. Furthermore, the magnetic performance was analyzed by intercalating various non-metallic elements (A=B, C, N, Al, Si, P, Ga, Ge, As).

FIG. 5 is a diagram of the Curie temperature according to the substitution of non-metallic element boron in CeFe₁₂B with 2nd period elements, 3rd period elements, and 4th period elements.

FIG. 5 shows the expected Curie temperature of the non-metallic elements intercalated CeFe₁₂ compound (CeFe12A) obtained from the density functional theory (DFT) calculation. In the Korringa-Kohn-Rostocker (KKR) approximation method, the coherent potential approximation was used and the Curie temperature was calculated using the mean field theory.

Referring to FIG. 5, it shows that the compound containing boron has a higher Curie temperature than the compound without the non-metallic element, indicated as Ce. This trend is also observed in the Curie temperatures of compounds containing carbon and nitrogen instead of boron. The data shows that the Curie temperature for the carbon-containing compound is the lowest, with the Curie temperature increasing in the order of carbon, boron, and nitrogen. It was found that the same trend was shown in the nonmetallic elements of the 3rd and 4th periods, and it was found that the carbon group elements showed a relatively low Curie temperature and the boron group and nitrogen group elements showed a relatively high Curie temperature in the order of boron group and nitrogen group elements.

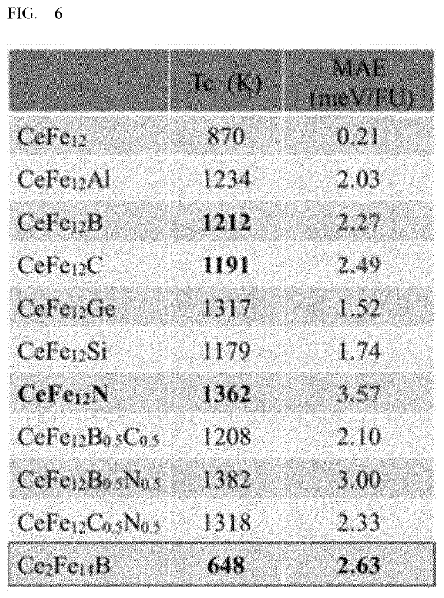

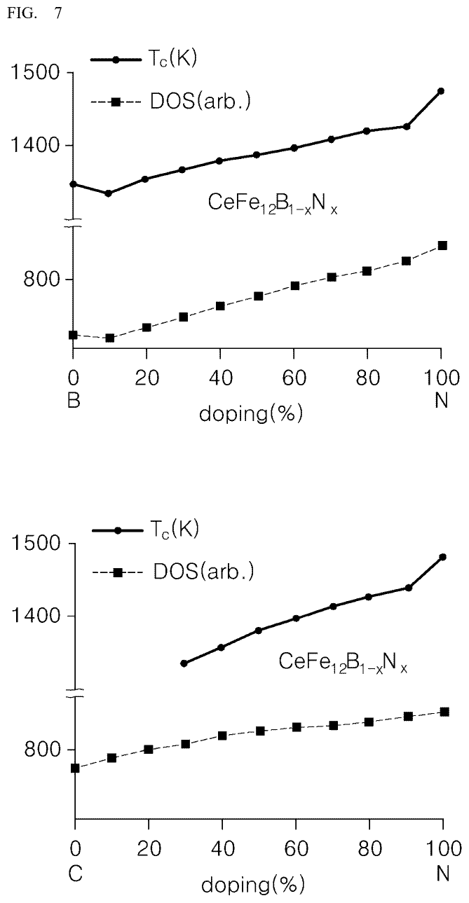

FIG. 6 is a table showing the Curie temperature and magnetic anisotropy energy calculated for CeFe₁₂-based compounds with various nonmetallic element (CeFe12A) using the density functional theory

In FIG. 6, combinations of non-metallic elements of the 2nd and 3rd periods are shown. Form the calculated Curie temperatures, it can be found that among various non-metallic elements, nitrogen-series cerium magnetic compounds, in particular, have a relatively high Curie temperature and will show excellent magnetic performance. Magnetic anisotropy energy is also an important factor in determining the performance of permanent magnets, and the nitrogen-substituted compounds show the largest magnetic anisotropy energy. This means that CeFe₁₂-based compounds, especially nitrogen-series compounds, should replace Nd₂Fe₁₄B and show high-performance magnetic properties.

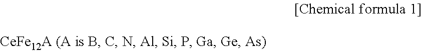

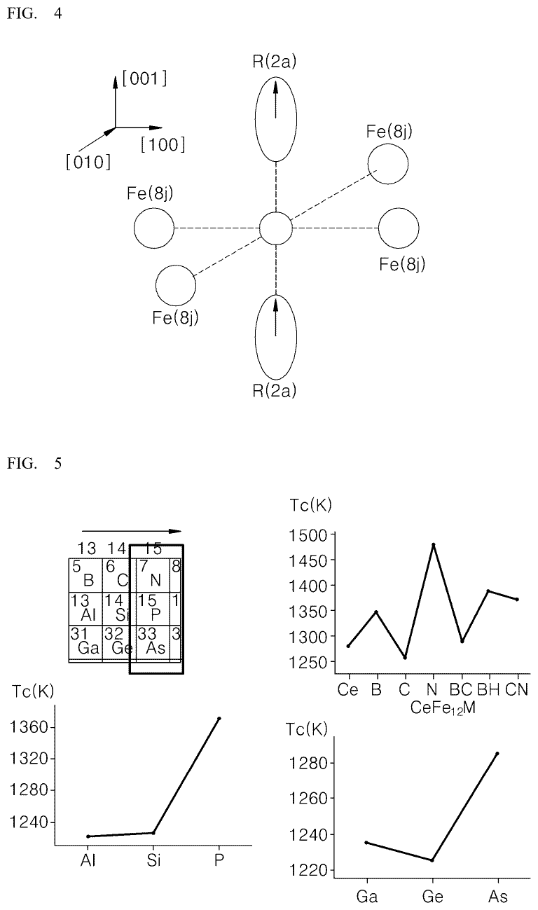

When nitrogen group N, P, and As, among the possible element in A site, are intercalated into the vacancy of CeFe₁₂ lattice (see FIG. 4), they act as electron donors in CeFe₁₂A, greatly increasing the Curie temperature and magnetic anisotropy, thereby improving the magnetic properties. This can be explained as follows: As shown in the correlation with the Curie temperature in FIG. 7, when A in CeFe₁₂A moves from the boron group to the nitrogen group (B→N), the electron density near the Fermi level increases. This increase in electron density leads to a rise in the Curie temperature (Tc), thereby improving the magnetic performance.

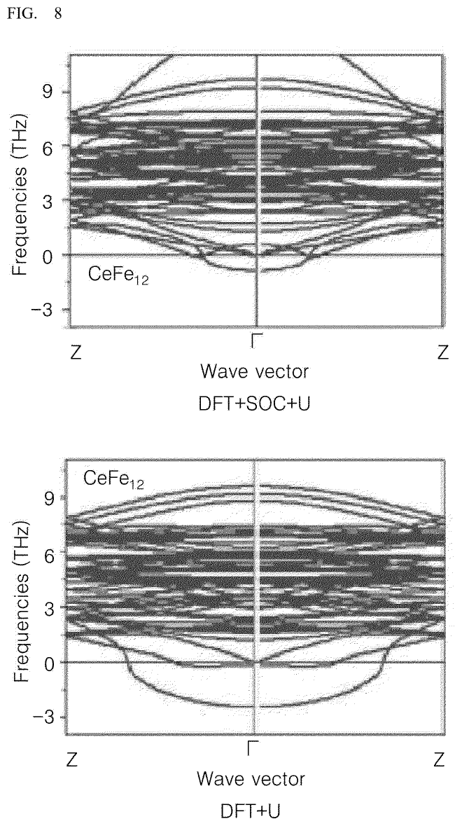

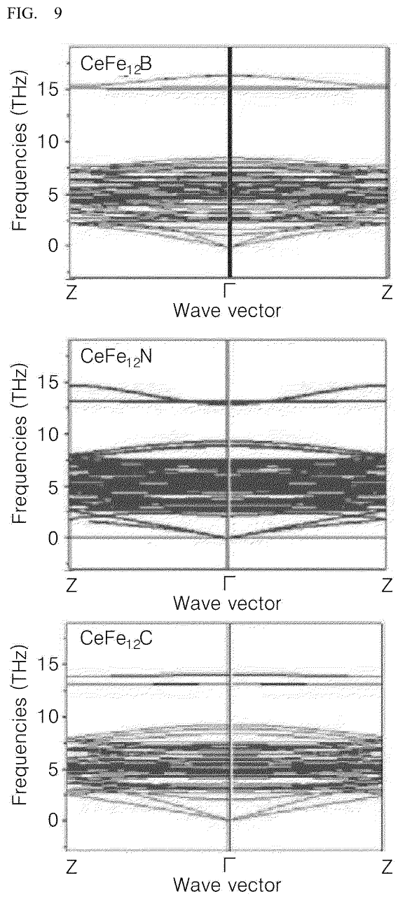

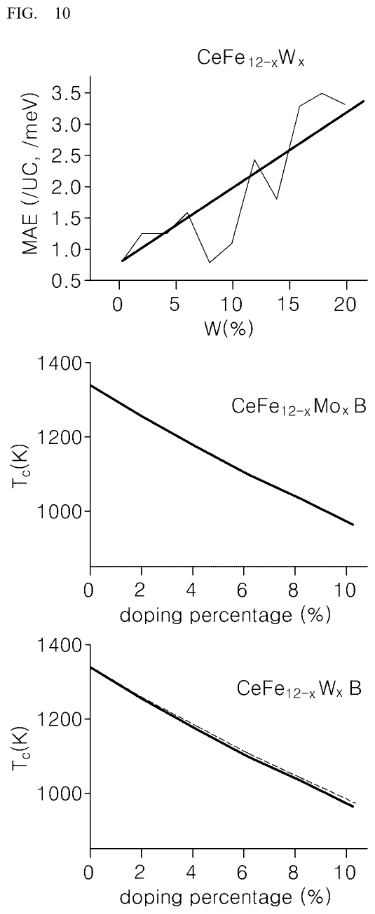

In addition, FIGS. 8 and 9, which show the behavior of phonons that predict dynamic stability, indicate that pure CeFe₁₂ is dynamically unstable, making its synthesis very difficult. In other words, pure CeFe₁₂ exhibits a negative frequency. While, when the negative phonon frequency of CeFe₁₂ disappears by the intercalation of A in CeFe₁₂ (where A is B, C, or N), it shows that the intercalation of A eliminates the instability of CeFe₁₂ and increases its magnetic anisotropy. It is understood that the nonmetallic element A, which acts as an electron donor in CeFe₁₂A, donates electrons to CeFe₁₂, and especially increases electrons to the Ce f-block to stabilize the Ce f-orbital, thereby eliminating the instability and increasing the magnetic anisotropy.

Induction of Magnetic Anisotropy Enhancement by Substitution of 4d and 5d Transition Metals with Large Spin-Orbit Coupling Effects at the Fe Site of CeFe₁₂, a Non-Rare-Earth Permanent Magnet Material CeFe₁₁M (M=4d, 5d Transition Metal)

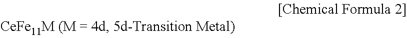

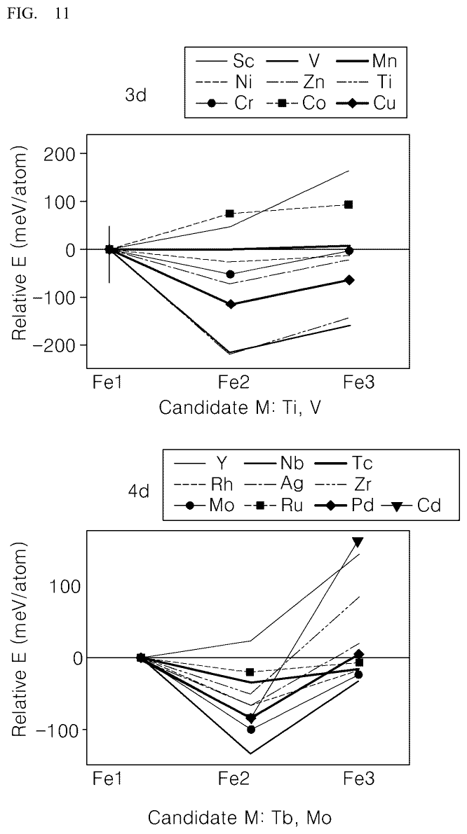

FIG. 10 is a graph for the theoretically predicted Curie temperature and magnetic anisotropy when substituting 4d and 5d transition metal elements with large spin-orbit coupling (SOC) effects at the Fe site of CeFe₁₂. Shown in FIG. 10, when Mo and W were doped at various concentrations in the Fe site, the Curie temperature gradually decreased as the doping concentration increased. However, as the Mo and W doping concentrations increased, the magnetic anisotropy increased rapidly. Thus, Mo and W doping is a useful method to improve the magnetic performance of CeFe₁₂, where, although the Curie temperature decreases to some extent, the magnetic anisotropy increases significantly when 4d and 5d transition metals, which have much larger spin-orbit coupling (SOC) effects than 3d transition metals, are partially substituted for the Fe element. In the compound of the above chemical formula 2, heavy elements such as Mo and W atoms are substituted at Fe site and form a coordination bond with Ce. In particular, it is understood that electronic localization and electric polarization is induced caused by the difference in spin-orbit interaction (SOC effect) with Fe, which leads greatly an enhancement of the magnetic anisotropy. However, from the intrinsic properties of 4d and 5d transition metal elements, the spin-exchange interaction is relatively weakened compared to pure CeFe₁₂, leading to a decrease in the Curie temperature (Tc). However, since the benefit of increasing magnetic anisotropy is greater than the decrease in Curie temperature, it is a useful method for improving the magnetic performance of CeFe₁₂.

$${\hat{H}}_{OOC} = λ \hat{S} \cdot \hat{L} \qquad [ Equation 4 ]$$

In this equation, H is the spin-orbit coupling Hamiltonian, λ is the spin-orbit coupling constant (proportional to the atomic number), S is the spin moment, and L is the orbital moment.

In the compound of the above chemical formula 2, Mo, W (4d, 5d-transition metal elements) are heavy atoms, so it is expected that the magnetic anisotropy will be large due to the strong spin-orbit interaction.

In the compound of the above chemical formula 2, when Mo, W are doped, Fe is trivalent Fe³⁺, while Mo, W have tetravalent M⁴⁺ oxidation numbers, which increases the number of electrons in the CeFe₁₂ system. However, in the case of Mo and W doped CeFe₁₂, from the intrinsic properties of 4d and 5d transition metals, the spin-exchange interaction is weaker than that of the 3d transition metal Fe, which causes the Curie temperature to decrease. It is understood that the magnetic anisotropy is enhanced by stabilizing the Ce f-orbital caused from the increased electron density on the Ce f-block, which leads to an increase in orbital angular momentum.

3d, 4d-Transition Metal Substitution in CeFe₁₁M for Dynamic Instability Control of CeFe12

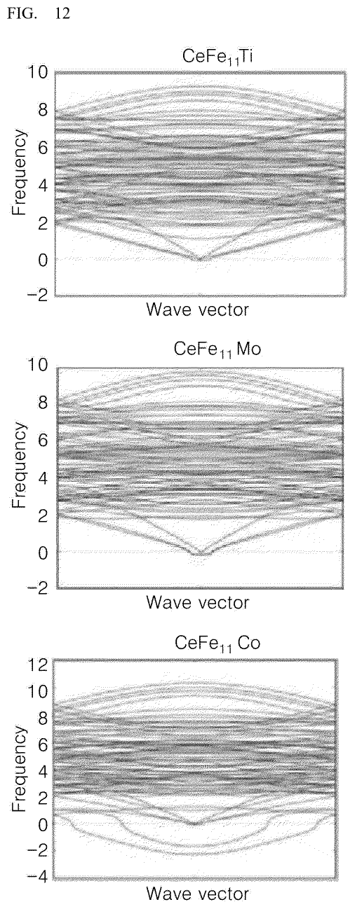

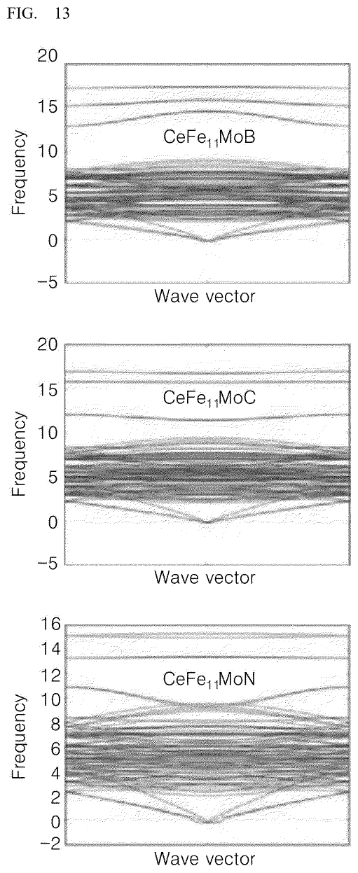

FIG. 11 is a graph showing the thermodynamic stability of candidate materials for the CeFe₁₂ series permanent magnets, according to an exemplary embodiment of the present invention. FIG. 11 is a graph that can predict the preferred positions and relatively easy-to-substitute elements when substituting 3d, 4d-transition metal elements for Fe sites in CeFe₁₂. In other words, it is a schematic diagram theoretically predicting the relative energy according to the type of M element and the substitution site when CeFe₁₁M is formed. Most transition metals have been shown to prefer the 8i position of Fe sites when substituting for Fe. It has been revealed that Ti, V, Nb, and Mo, which have larger atomic sizes than Fe, are preferred candidates for substitution. In particular, the Fe 8i site is relatively close to Ce compared to the 8f and 8j sites, so it is expected that the interaction with Ce will be relatively strong. When the Ce f-orbital is unstable or electron-deficient, doping the Fe 8i site nearest to the Ce atom with elements larger than Fe should enhance the interaction with the Ce f-orbital, stabilize it, and thereby should control the structural instability of CeFe₁₂. In fact, analyzing the phonon behavior of CeFe₁₁M shown in FIG. 12, the dynamic stability of CeFe12 is resolved when Ti and V atoms larger than Fe are substituted, but the dynamic stability is not resolved in the case of Co smaller than Fe. Therefore, the way of substituting a transition metal larger than Fe to the Fe site on CeFe₁₂ to increase the interaction with Ce is a very useful method for overcoming the dynamic instability of CeFe₁₂.

FIG. 13 is a graph showing the phonon behavior of CeFe₁₁MA (A is B, C, N) in which M is substituted in CeFe₁₂ to form CeFe₁₁M and B, C, N are intercalated into the loose site of the CeFe₁₁M lattice. In the FIG. 13, when B, C, N are intercalated into CeFe₁₁M, dynamic stability is maintained. This result suggests that if there is difficulty in intercalating B, C, or N in future experiments, substituting M first and then intercalating B, C, or N should make their intercalation easier. Additionally, the magnetic properties of CeFe₁₂ could be significantly improved, and the instability of the material should could also be eliminated.

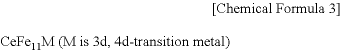

In the chemical formula 3 above, elements with a larger atomic size than Fe are advantageous among the 3d, 4d-transition metals (e.g. Ti, V, Nb, Mo, etc.).

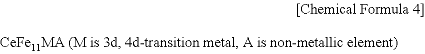

In the chemical formula 4 above, M is preferably a transition metal atom with an atomic size larger than Fe, and A=nitrogen group atoms are preferably used.

In the case of the compound 3 above, there is a disadvantage that the Curie temperature decreases to some extent, but it is meaningful because it can resolve the dynamical instability of CeFe₁₂. Although CeFe₁₂ is a material that is difficult to synthesize and apply, this chemical composition makes it possible to synthesize and apply it as a permanent magnet material.

In the case of compound 4 mentioned above, it is a way that can greatly increase the magnetic anisotropy of compound 3. Its principle is the same as that of CeFe₁₂A, in which non-metallic elements A are intercalated. That is, non-metallic elements act as (B, C, N) electron donors to provide electrons to CeFe₁₁M (M=3d, 4d-transition metal), thereby enhancing the Curie temperature. Furthermore, the intercalated A interacts with adjacent Ce and transition metals, increasing the electron density in the system and, in particular, provides electrons to the Ce f-orbital, thereby leading the stabilization and electric polarization of it. As a result, magnetic anisotropy is significantly enhanced caused from the increase in orbital angular momentum. Therefore, the attempt to synthesize compound 4 after synthesizing compound 3 is highly desirable and is considered a way that should greatly contribute to the synthesis and application of CeFe₁₂ series permanent magnets.

Although the present invention has been described in the detailed description of the invention with reference to exemplary embodiments of the present invention, it will be understood to those skilled in the art that various modifications and variation can be made in the present invention without departing from the spirit or scope of the invention.

1. A permanent magnetic material, as a CeFe₁₂A compound, in which inserted A forms a coordination bond between Ce-A-Ce.

2. The permanent magnetic material of claim 1, wherein negative frequency of CeFe₁₂ is removed from the phonon behavior by insertion of the A.

3. The permanent magnetic material of claim 1, wherein the A are atoms of which outermost electrons do not include d-orbital electrons.

4. The permanent magnetic material of claim 1, wherein the A includes at least one selected from B, C, N, Al, Si, P, Ga, Ge, and As.

5. A permanent magnetic material expressed as CeFe₁₁M in which a transition metal M with an atomic size larger than Fe is substituted to eliminate the dynamic instability of CeFe₁₂.

6. The permanent magnetic material of claim 5, wherein the transition metal M includes at least one of a 4d-transition metal or a 5d-transition metal.

7. The permanent magnetic material of claim 5, wherein the transition metal M includes at least one of Ti, V, Cr, Zr, Nb, and Mo.

8. A permanent magnetic material as CeFe₁₁MA compound, wherein M contains at least one of a 4d-transition metal or a 5d-transition metal, and A are atoms whose outermost electrons do not contain d-orbital electrons.

9. The permanent magnetic material of claim 8, wherein the M includes at least one selected from Ti, V, Cr, Zr, Nb, and Mo, and the A includes at least one selected from B, C, N, Al, Si, P, Ga, Ge, and As.

10. A permanent magnet comprising a permanent magnetic material according to claim 1.
